(19) United States
(12) Patent Application Publication
(10) Pub. No.: US 2012/0102878 A1
(43) Pub. Date: May 3, 2012

(54) MOSAIC TESSERAE OR TILES FEEDING DEVICE AND MACHINE USING SAID DEVICE

(76) Inventors: Luciano Morini, Firenze (IT); Jovanka Pizzo, Prato (IT)

(21) Appl. No.: 13/382,173

(22) PCT Filed: Jul. 2, 2010
(86) PCT No.: PCT/IT2010/000298

§ 371 Date: Jan. 4, 2012

(30) Foreign Application Priority Data
Jul. 7, 2009 (IT) FI2009A000148

(51) Int. Cl. B65B 1/04; G01F 11/20

(52) U.S. Cl. 53/235; 222/410

(57) ABSTRACT

The orienting device (101) comprises a hopper (103) for containing tiles (P) with an exit mouth for the exit of the tiles, wherein to the exit mouth a rotating member (111) is associated, provided with a plurality of annular channels (115), of cross dimensions corresponding to a dimension of said tiles.

### TECHNICAL FIELD

The invention relates to machines and plants for handling mosaic tesserae or tiles, and in particular machines, devices and plants for filling trays with said tiles according to a preset pattern.

### STATE OF THE ART

In the building sector, for covering floors or walls, tiles, also called tesserae, are used, typically in the order of 1 to 3 cm per side, which in some cases are arranged according to preset patterns. These tesserae or tiles, made of glass, ceramic or other materials, have two opposite surfaces, a back surface or back face, and a front surface or front face, i.e. a so-called beautiful face that, when the tile is installed, remains visible and forms the covering or the floor.

These tesserae or tiles are usually arranged in trays or grids of adequate dimensions to form groups of tesserae or tiles, usually with rectangular or square shape, wherein the tesserae or tiles are joined one to the other by means of a plastic film, a net, a paper sheet or other else. In this way, each group of tesserae or tiles can be installed as a single piece, i.e. as it were a tile with dimensions equal to the dimension of the tray, thus accelerating the installation process and making it simpler. For filling these trays it is necessary previously to orient all the tiles or tesserae in the same direction, i.e. all with the same face or surface (front or back) directed upwards. Usually, even if not necessarily, this direction is made so as to arrange all the tiles or tesserae with the beautiful surface or face oriented upwards and the back surface or face oriented downwards, i.e. on the rest surface on which they move.

To fill the various seats of a grid or tray according to a preset pattern of tiles, various types of devices are known, which however are unsatisfactory in terms of accuracy and/or fill speed.

A further problem is that not all the tesserae or tiles can be easily handled by the existing machines and devices. In particular, the tesserae of small dimensions, for example 1×1 cm, can be handled with difficulty.

The process of orienting tiles, preceding the insertion thereof in the seats of the trays, must be as accurate as possible to avoid mistakes in positioning the tesserae or tiles in the grid or tray. At the same time, the process must be fast, so as to obtain an adequate hourly production of trays filled with the tiles correctly oriented.

### SUMMARY OF THE INVENTION

According to one aspect, the present invention provides a new feeding device for mosaic tesserae or tiles, which has a particularly simple and reliable structure, suitable to achieve high productivities with a high reliability.

In one embodiment the invention provides a feeding device for feeding mosaic tesserae or tiles, comprising a hopper for containing the tiles with an exit mouth for the exit of the tiles, wherein with said exit mouth a rotating member is associated, which is provided with a plurality of adjacent annular channels arranged along the axial development of said rotating member, the cross dimensions of said annular channels being such as to allow the insertion of said tiles in said channels, and wherein the rotation of said rotating member causes the supply of said tiles from said annular channels into corresponding feeding channels adjacent one to the other, in a number corresponding to the number of annular channels in said rotating member.

In a second embodiment the present invention comprises a orienting device for orienting mosaic tesserae or tiles, comprising a containing hopper for containing the tiles with an exit mouth for the exit of the tiles, wherein to said exit mouth a rotating member is associated, provided with a plurality of annular channels, with cross dimensions corresponding to a dimension of said tiles. In some embodiments, a rotating member is provided, fitted with a plurality of annular channels, with such cross dimensions as to allow the insertion of said tiles only according to a preset orientation.

In some embodiments, to the rotating member a contrast element is associated, which prevents the tiles oriented in an incorrect manner from being inserted in said annular channels. In preferred embodiments of the invention, around said rotating member a wall extends, defining the angular position of discharging the tiles from the annular channels. To the wall an agitating element can be associated for agitating the tiles, which facilitates the insertion of the tiles in the annular channels of the rotating member.

To the exit of the hopper a conveyor for conveying the tiles can be associated, with a plurality of feeding channels in a number corresponding to the number of annular channels in said rotating member. The conveyor can be a simple inclined wall, where the tiles move due to gravity, or a vibrating conveyor, but it is also possible to use a feeding belt to facilitate the feed of the tiles, for example along a trajectory which is slightly inclined with respect to the horizontal.

In some embodiments, at the exit of said feeding channels a movable support is arranged, suitable to receive in a sequential manner rows of tiles from said feeding channels. The movable support can be provided with an oscillating movement around an axis substantially orthogonal to said feeding channels.

The invention also provides a machine for filling trays with mosaic tesserae or tiles, which uses a device of the type described above. More in particular, according to one embodiment the invention provides for a filling machine for filling trays with mosaic tesserae or tiles, comprising at least one rotating table, rotatable about an axis of rotation with respect to a bearing structure, and at least one selective filling device for filling a tray of mosaic tesserae or tiles, wherein on the rotating table a plurality of feeding devices, of the type defined above, is arranged, and wherein said rotating table is controlled so as to carry selectively one or the other of said feeding devices to a filling position.

In some embodiments the selective filling device is supported in said filling position and interacts selectively with a plurality of said feeding devices.

In some embodiments the filling device comprises:
a series of gripping elements, each of which can be actuated and disabled selectively, aligned with said feeding channels and with the movable support of the feeding device which is at said selective filling device, so as to pick up the tiles from the movable support associated to the feeding device which is at the filling device, and to transfer them selectively in seats of a tray being filled;
below said series of gripping elements, support means, on which said trays are arranged, so as to receive selectively the tiles from said gripping elements.

In an improved embodiment the gripping elements are controlled by a first common actuator to perform a first lowering movement, wherein each gripping element is provided with a second individual actuator to perform a second lowering movement constituted by an over-travel relative to said first lowering movement, to allow each gripping element to be lowered beyond a common lowering position to which said gripping elements are brought by said first common actuator.

Advantageously, the trays and the gripping elements are provided with a reciprocal movement, so that with subsequent operations the gripping elements place tiles into subsequent rows of said tray.

In some embodiments each of said gripping elements comprises a sucker or other retaining suction system.

Preferably, the gripping elements are provided with a lowering and lifting movement from a height at the level of the exit of the feeding channels to a height of discharging tiles in a tray below and vice versa.

In some embodiments the gripping elements are electronically controlled so as to transfer, in subsequent rows of seats in said tray, tiles according to a preset pattern, through selective disabling of the gripping elements corresponding to positions of seats inside which said tiles must be inserted and maintaining active the gripping elements corresponding to seats into which said tiles must not be inserted.

In some embodiments, to said at least one rotating table at least one handling member is associated for a plurality of trays, controlled and arranged so as to feed sequentially a plurality of trays to said rotating table. In some embodiments, the handling member comprises a plurality of seats in which corresponding trays for said tiles can be inserted and from which they can be extracted. For example the handling member can comprise a carousel with said plurality of seats, rotatable about an axis so as to move said seats according to a circular trajectory. It is also possible to use a handling member of different shape, for example with rectilinear development and provided with a translation movement.

The machine can comprise handling members for controlled handling, according to a numerically controlled axis of the trays, in the direction of insertion and extraction of the trays from the respective seats, so as to fill selectively said trays according to rows of tesserae or tiles extending orthogonally to the direction of insertion and extraction.

Further advantageous features and embodiments of the feeding device and of the machine according to the present invention are described hereunder with reference to an example of embodiment and are set forth in the appended claims, which form an integral part of the present description.

### BRIEF DESCRIPTION OF THE DRAWINGS

The invention will be better understood by means of the description below and the attached drawing, which shows a non-restrictive practical embodiment of the invention and various configurations that can be obtained assembling machine modules according to the present invention. More in particular:

FIG. 1 shows a section according to a vertical plane of a feeding device according to the invention;

FIGS. 1A and 1B show details of the exit area of the tails from the hopper of the feeding device;

FIG. 2 shows an axonometric view from the outside of the device of FIG. 1;

FIG. 3 shows a side view of the rotating member of the feeding device of FIGS. 1 and 2;

FIG. 3A shows a detail of the rotating member of the feeding device with tiles or tesserae inserted in the channels defined by the member itself;

FIG. 3B shows a tile to be oriented;

FIG. 4 shows a plan view of a machine according to the invention with a single module;

FIG. 5 shows an axonometric view of the machine of FIG. 4;

FIG. 6 shows a side view according to VI-VI of FIG. 4;

FIGS. 7, 8, 9, and 10 show a plan view of various configurations which can be obtained assembling more modules of machine according to the invention;

FIG. 11 shows a schematic plan view of a tray filled with tiles of various colors using a device according to the invention;

FIGS. 12 and 13 show a side view and a plan view of a possible embodiment of the filling device for filling trays with the tiles or tesserae fed and directed by the feeding devices of a machine according to the invention;

FIGS. 14D and 14D show an example of operating sequence for a better understanding of the function of the filling device of FIGS. 12 and 13;

FIGS. 15A and 15B show a schematic front view and the functioning methods of the filling device in an improved embodiment; and

FIG. 16 shows a plan view of a possible alternative embodiment of a filling machine for filling tray according to the present invention.

### DETAILED DESCRIPTION OF EMBODIMENTS OF THE INVENTION

Hereunder a feeding device is described, also having the function of orienting device for orienting the tiles or tesserae. It will be therefore usually defined orienting device. However, it should be understood that the device can be used also with tiles that do not allow or do not require orientation, and in this case the device, substantially maintaining the same structure, will perform only the feeding function.

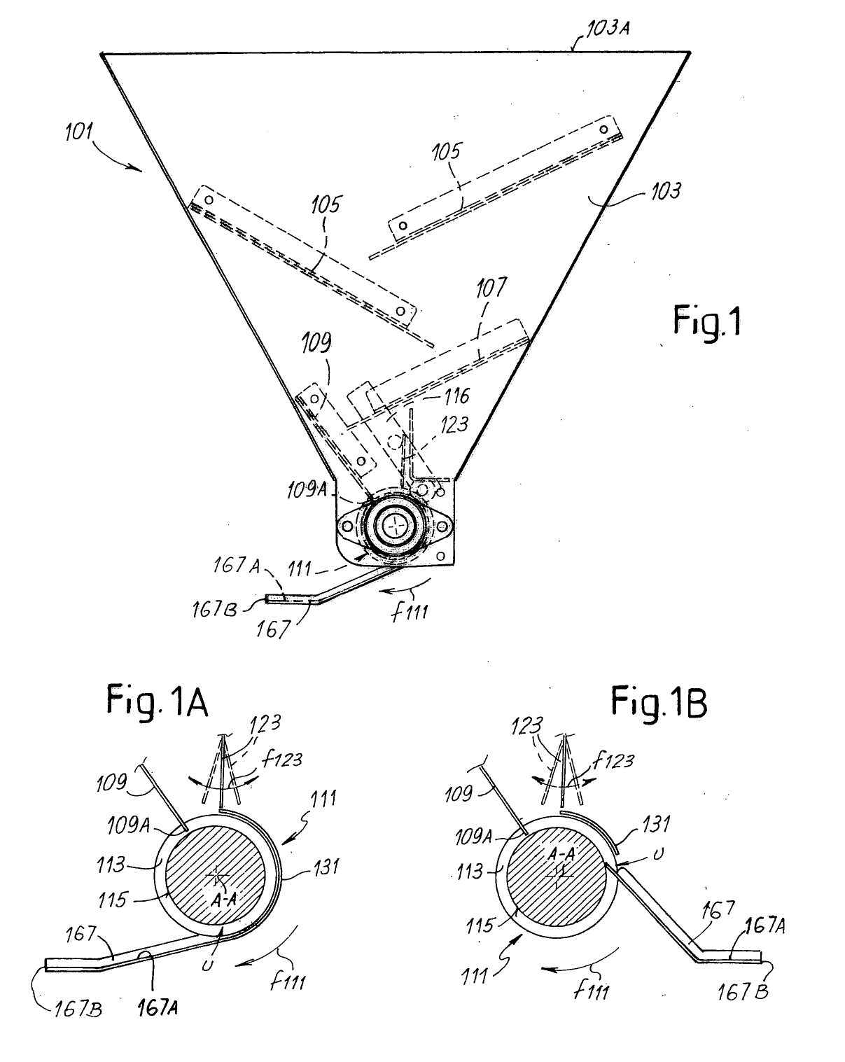

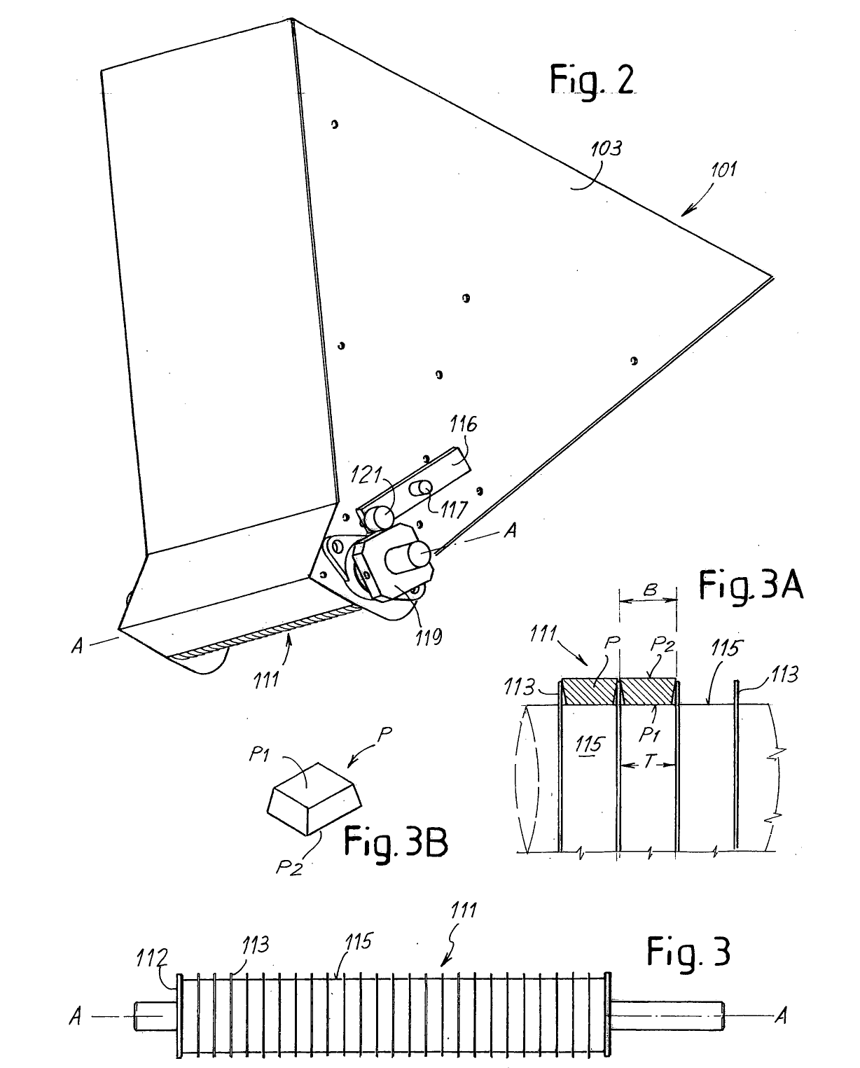

With initial reference to FIGS. 1 to 3, the orienting device according to the invention, indicated as a whole with number 101, comprises a hopper 1203 with an upper aperture 103A, in which are inserted randomly the tesserae or tiles P that the device must feed in an oriented manner, i.e. all with the beautiful face upwards or all with the beautiful face downwards, to a conveyor described below.

Inside the hopper 3 baffles 105, 197, and 109 can be arranged. One or more of said baffles can be movable so as to act as agitators suitable to prevent the formation of bridges that can block the correct feed of the loose material towards the bottom of the hopper. In other embodiments agitating means can be provided expressly designed, for example in the form of brushes, rotors or other.

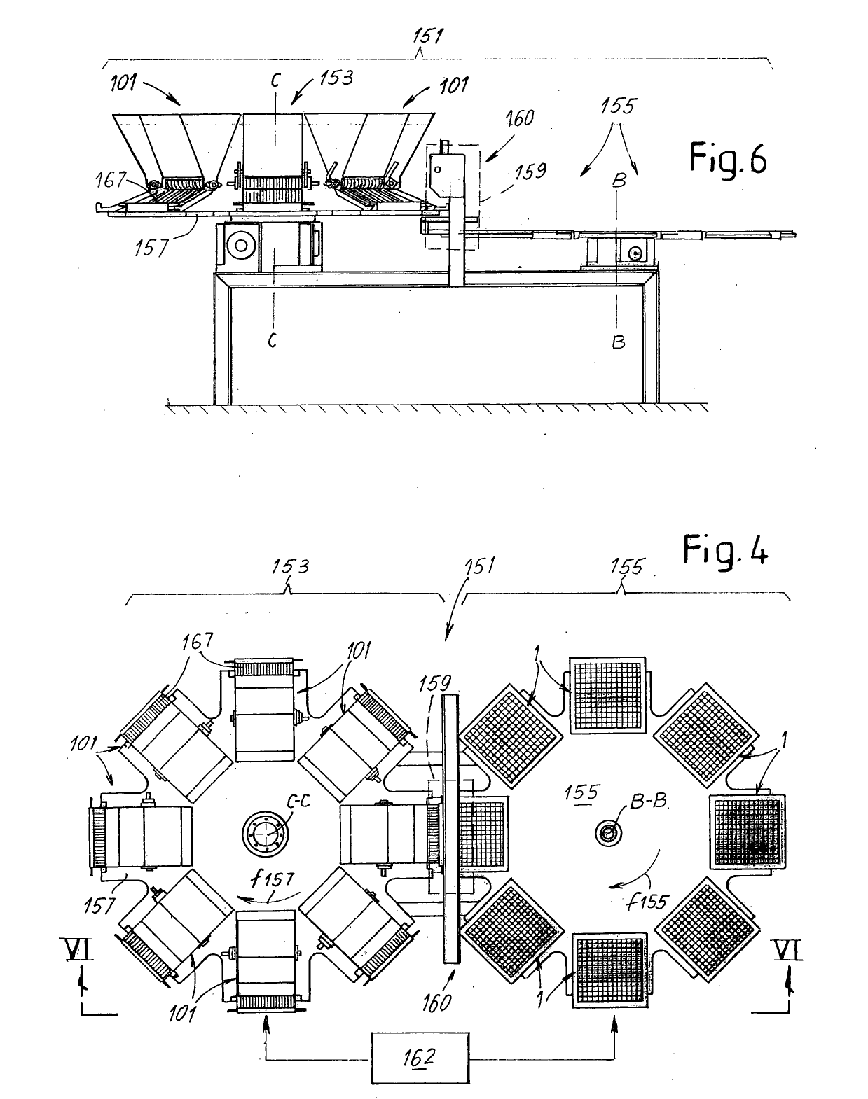

The bottom of the hopper 103 houses a rotating member 111, described in greater detail below with reference to FIG. 3, which shows it isolated from the remaining parts of the device 101.

The rotating member 111 is substantially constituted by a roller with a central core 112, to which rings 113 are fixed, which define a plurality of channels 115 of dimensions defined according to the dimensions of the tesserae or tiles P to be oriented, as illustrated in FIGS. 3A and 3B.

Substantially, the cross dimension T of each channel 115 is slightly smaller than the dimension B of the greater base of a tile P to be oriented. The tiles P, as shown in particular in FIG. 3B, usually have slightly tapered or rounded flanks, so that the dimensions of the two faces P1 and P2 differ from one another. The configuration of the rotating member formed with the channels 115 is such that the tiles can enter oriented as illustrated in FIG. 3A, i.e. with the face of smaller dimensions P1 facing the axis A-A of the rotating member and the face of greater dimensions P2 facing the outside of the channel 115. An opposite orientation, i.e. with the greater face P2 inside the channel, is not possible due to the cross dimension T of the channel 115.

With this conformation, putting the rotating member 111 into rotation in the bottom of the hopper 3, all the tiles distributed randomly in the same hopper 103 enter in the various channels 115 in the arrangement illustrated in FIG. 3A, i.e. all oriented in the same manner with the face of smaller dimensions P1 facing the bottom of the channels 115.

A similar function can be obtained when the side walls of the tiles P have a curve shape instead of a planar one, provided that there is a dimensional difference between the faces P1 and P2. In some embodiments, the rings 113 can have opposite walls shaped in a different manner than that represented in the drawing, for instance divergent or convergent, rounded or plan walls.

As it will be better explained below, according to how the discharge or exit system is configured for discharging the tiles P from the orienting device 101 it is possible to feed all the tiles P from the channels 115 towards the outer conveyors, arranging all the tiles with the face P1 or with the face P2 facing downwards, according to the needs of the stations downwards the orienting device.

In the illustrated example to the hopper 103 an oscillating arm 116 is associated, arranged outside a flank of the hopper. The arm is hinged around a pin 117 so that it can oscillated under the thrust of a cam 119 keyed on the axis A-A of the rotating member 111. Reference 121 indicates a tracing roller carried by the oscillating arm 116 and acting on the cam 119. A spring, not shown, can stress the arm 116 so as to push the tracer 121 constantly against the profile of the cam.

In this way the rotation of the rotating member 111 entails an oscillating movement of the axis of the pin 117. To this latter is connected an oscillating member 123 that, in the illustrated example, is formed by a sheet, or other suitable agitating member, for instance a brush. The lower end of the oscillating member 123 is arranged close to the cylindrical surface defined by the external edges of the rings 113. In this way the action of the agitator 123 facilitates the distribution of the tiles in the channels 115.

In a position opposite to the oscillating member 123 the baffle 109 is arranged, whose lower end 109A is teeth-shaped to penetrate in the annular channels 115, so as to avoid the exit of tiles or tesserae P towards the outside and to force the tiles to be channeled in the channels 115 to be drawn by the rotation according to the arrow f111 of the rotating member 111 towards an exit area below.

FIG. 1A schematically shows a section according to the axis A-A of the rotating member 111. FIG. 1A also shows the terminal part 109A of the baffle 109 which penetrates in the channels 115 formed between the rings 113 and the oscillating member 123, whose oscillating movement is indicated with f123.

Around a part of the circumferential development of the rotating member 111 a cylindrical surface 131 develops, with the concavity facing the axis of the rotating member 111. The diameter of the cylindrical surface 131 is substantially corresponding to, or slightly greater than the maximum diameter of the rings 113. In this way the tiles P inserted in the channels 115 and drawn by the rotation movement of the rotating member 111 pass below the cylindrical surface 131 and are held by it inside the channels 115 until an exit area U where the surface 131 is interrupted or changes shape to allow the discharge of the tiles. Downstream of the area U extends a slide, an inclined wall, a conveyor or any other removing means for removing the tiles, generically indicated in the drawing as a surface 133.

It is understood that with this arrangement the tiles P that are inserted in the channels 115 as shown in FIG. 3A will be discharged on an outer conveying surface 133, all oriented with the face of lower dimension P1 facing upwards.

FIG. 1B shows an alternative arrangement, wherein the same numbers indicate the same or equivalent parts to those of FIG. 1A In this embodiment the cylindrical part or surface 133 has an angular development lower than that of FIG. 1A, and ends nearly at the height where there is the axis A-A of rotation of the rotating member 111. In this position a discharge or exit surface 133 is provided, for discharging the tiles, on which the tiles, exiting from the volume defined between the rotating member 111 and the cylindrical surface 131, exit due to gravity oriented in an manner opposite to that in which the tiles exit from the orienting device in the arrangement of FIG. 1A, i.e. with the surface or face of greater dimensions P2 oriented upwards. According to the desired orientation for the tiles exiting from the device 101, this can be arranged as in FIG. 1A or in FIG. 1B.

With an orienting device of this type it is therefore possible to feed on a conveyor of any configuration, also simply an inclined surface where the tiles move due to gravity, tiles or tesserae P all oriented in an adequate manner according to the operations to be executed on them downstream of the orienting device 1.

By observing FIG. 3A it can be understood that when the tesserae or tiles P, P2 do not have a dimensional difference between the two faces, the device 101 can be used for the ordered feed of tiles or tesserae in the feeding channels 167A. In this case the tesserae or tiles P are inserted in the annular channels 115 and fed by them in an ordered manner towards exit or feed channels. In this case the orientation will not be between front face and back face of the tile, but only an orientation of the tile will be obtained with its own edges parallel to the rings 113 defining the walls of the annular channels. The single tiles are therefore fed to the exit in an oriented manner, even if alternatively with one or the other of the main faces facing upwards.

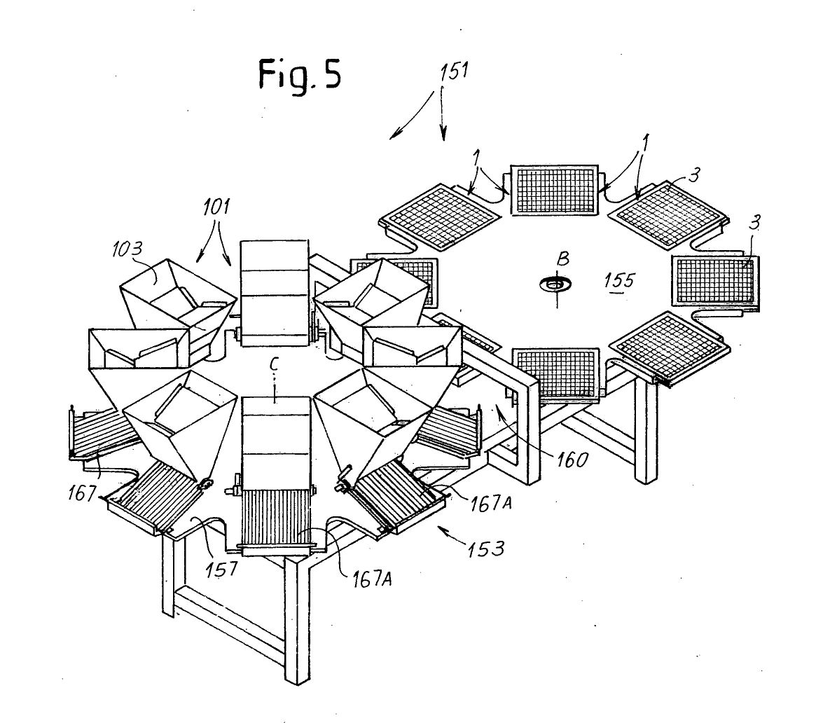

In FIGS. 4, 5, and 6 a filling station is shown for filling trays 1 with tesserae or tiles P fed by a plurality of orienting devices 101 of the type described above. In the illustrated example, as it will be more apparent below, eight orienting devices are used in combination to fill in sequence a plurality of trays 1 with eight different types of tiles. Each orienting device 101 can feed tiles of a type different from the other devices, for example tiles of different colors or materials. It is also possible to feed with different devices tiles of different dimensions, using trays with seats for housing the tiles of suitable dimensions.

Each tray is provided with a plurality of seats, each of which must be filled with a respective tile or tessera selected from one or the other of the eight groups of tiles fed in an oriented manner by the single orienting devices 101.

More in particular, to each device 101 a filling station 151 is associated, comprising a filling machine 153 and a carousel 155 for feeding and moving the trays 1. The carousel 155 rotates around a substantially vertical axis B-B parallel to an axis C-C of rotation of a rotating table 157 forming part of the filling machine 153. On the rotating table 157, with a substantially star shape, the eight orienting devices 101 are arranged, each of which designed as described with reference to FIGS. 1 to 3. As mentioned above, in each hopper 103 of the various orienting devices 101 different tiles can be arranged for each orienting device 101, for example tiles which differ one from the other in the color. In this way, each orienting device 101 can be used to orient the tiles of a respective color to be inserted in the seats 3 of the respective trays 1.

The rotation, controlled by a programmable, advantageously bidirectional control device, according to the arrows f155 and f157 of the carousel 155 and of the rotating table 157, allows to bring in mutually coinciding and opposite positions each orienting device 101 with each tray 1 arranged on the carousel 155. In a filling position 160, intermediate between the rotating table 157 and the carousel 155, a selective filling device is arranged, schematically indicated with a broken line with number 159 in FIG. 4. The selective filling device 159 can be of any nature. In some cases it can comprise simply one or more sucking members which pick up individually the tiles from the exit conveyors of the devices 101 and insert them in the correct seats of the trays according to a preset pattern. The sucking members can be carried by robotized arms, controlled according to numerically controlled axes x, y, and z.

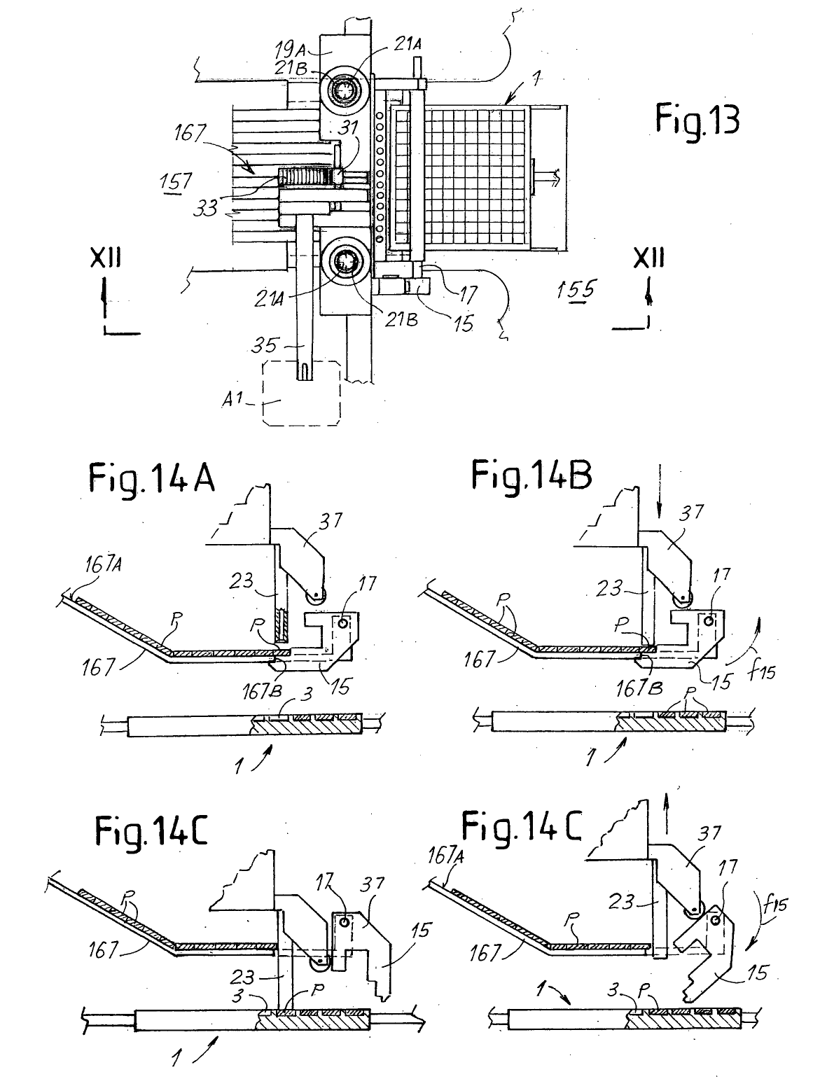

A different arrangement of the filling device, which allows to obtain a more efficient and faster functioning, will be described in greater detail with reference to FIGS. 12 to 14.

Briefly, and with reference to the description below for a more detailed illustration of an advantageous embodiment, the selective filling device 159 provides for arranging tile selectively picked up from one or the other of the orienting devices 101 in defined seats 3 of trays 1 selected among those carried by the carousel 155. With an electronic control performed by a control unit schematically indicated with 162, it is possible in this way to fill each tray 1 with any arrangement of tiles of eight distinct colors, each color being associated to a respective orienting device 101.

Therefore, filling of the trays 1 arranged on the carousel 155 occurs for example by positioning the first tray 1 in the filling position 160 and filling the various seats 3 of the tray 1 with one or more colors supplied by the orienting devices 101 positioning for each color the respective device 101 in the position 160, so that the members of the selective filling device 159 can pick up the corresponding tiles and insert them in the seats selectively identified by the programmable control devices 162. With this arrangement it is therefore possible to form patterns in eight different colors in all the trays 1 arranged on the carousel 155. Obviously, the single trays can be filled with the same pattern or with patterns different from tray to tray, as the control unit 162 is able to give commands for rotating and moving the various members allowing generating different patterns in different trays.

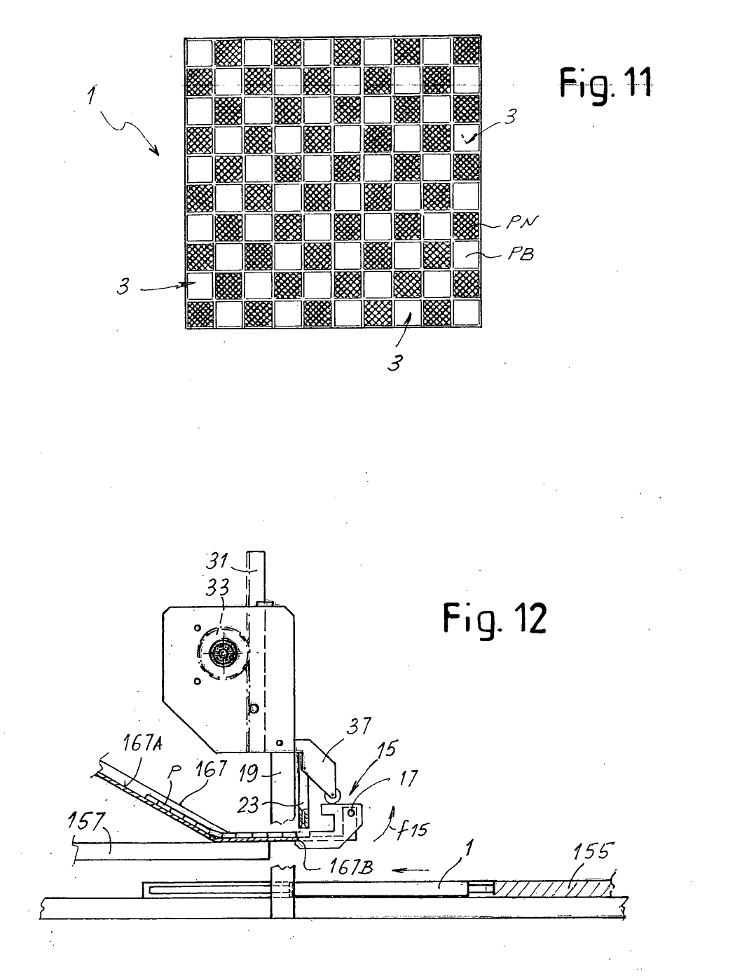

FIG. 11 schematically indicates a chessboard pattern which can be obtained with a machine of this type using only two colors, for example white and black. PN and PB indicate respectively black and white tiles arranged in a chessboard manner in the tray 1, each tile being inserted in a respective seat 3. In this way it is possible to fill four hoppers 103 of four devices 101 with black tiles and four hoppers 103 of the remaining orienting devices 101 with white tiles. Obviously, using different colors it is possible to obtain different and more complex patterns.

At the exit of each orienting device 101 a conveyor is arranged that, in the illustrated example, comprises an inclined surface 167 constituting the elongation of the surface 133, on which single feeding channels 167A are obtained, for example through walls or sheets orthogonal to the surface 167. Each feeding channel 167A receives a row of tiles and is aligned with a corresponding annular channel 115 of the rotating member 111 arranged on the bottom of the respective hopper 103. The feeding of tiles along the channels 167A of the conveyors 167 can occur simply due to gravity or with the aid of a vibrating system. It is also possible to use a movable belt defining the bottom of each channel 167A to facilitate the feeding of the tiles, for example with a conveyor 167 which is not inclined, or which is inclined less than what represented in the example illustrated in the drawing.

At the end of the conveyor 167 opposite to the end receiving the tiles from the corresponding hopper 103 there are members, described, below, that allow selective picking up of tiles from each conveyor 167 and inserting them in the seats 3 of the trays 1.

FIGS. 1 to 7 show a plan view of different conformations of the filling station 151. Each configuration can be obtained by combining a variable number of carousel 155 and filling machines 153, so as to fill the trays 1 with a greater number of tesserae or tiles P different one from the other in quality or color, or also in dimension.

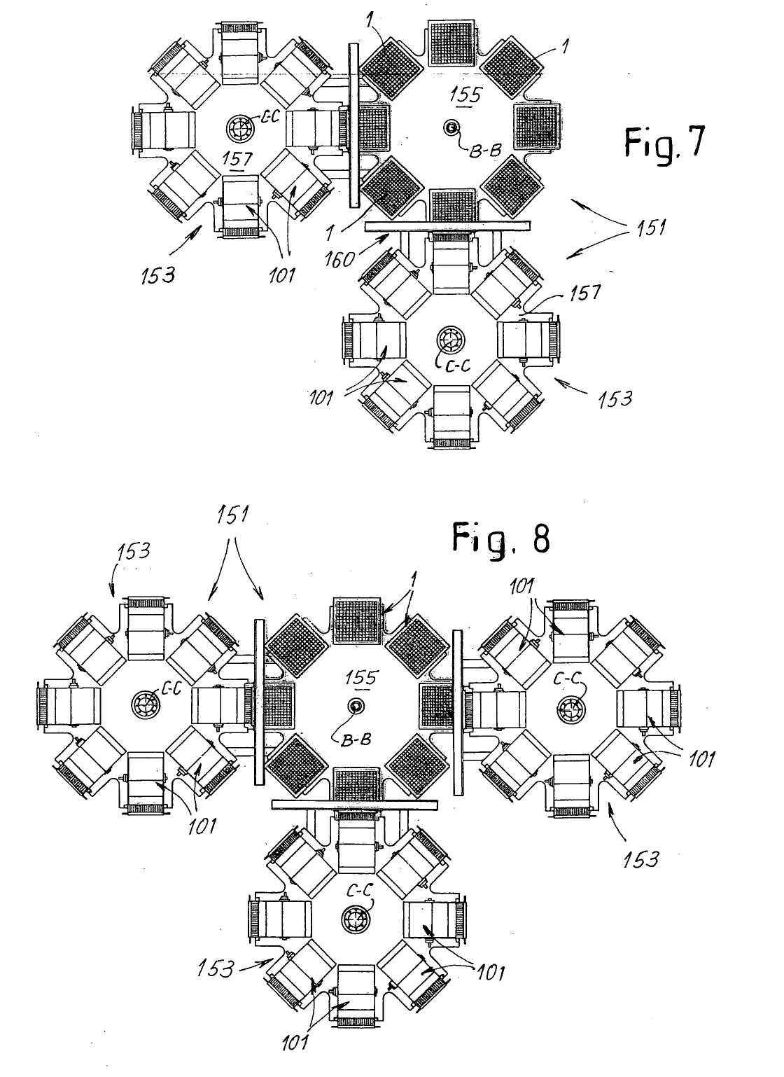

More in particular, FIG. 7 shows a filling station 151 with a single carousel 155 which serves two filling machines 153. Each machine can be configured as described above with reference to FIGS. 4 to 6. In this case the trays 1 can be filled with tiles P of 16 different types, for example 16 different colors. The rotation of the carousel 155 around the axis B-B and of the rotating tables 157 around the respective axes C-C are controlled by a central unit 162, not shown in this figure, so as to optimize the times for filling the various trays 1.

FIG. 8 shows a different configuration of the filling station 151 which comprises again a single carousel 155 interfaced with three distinct filling machines 153, each designed as described with reference to FIGS. 4 to 6. In this way it is possible to fill the trays 1 with tesserae or tiles of 24 different types.

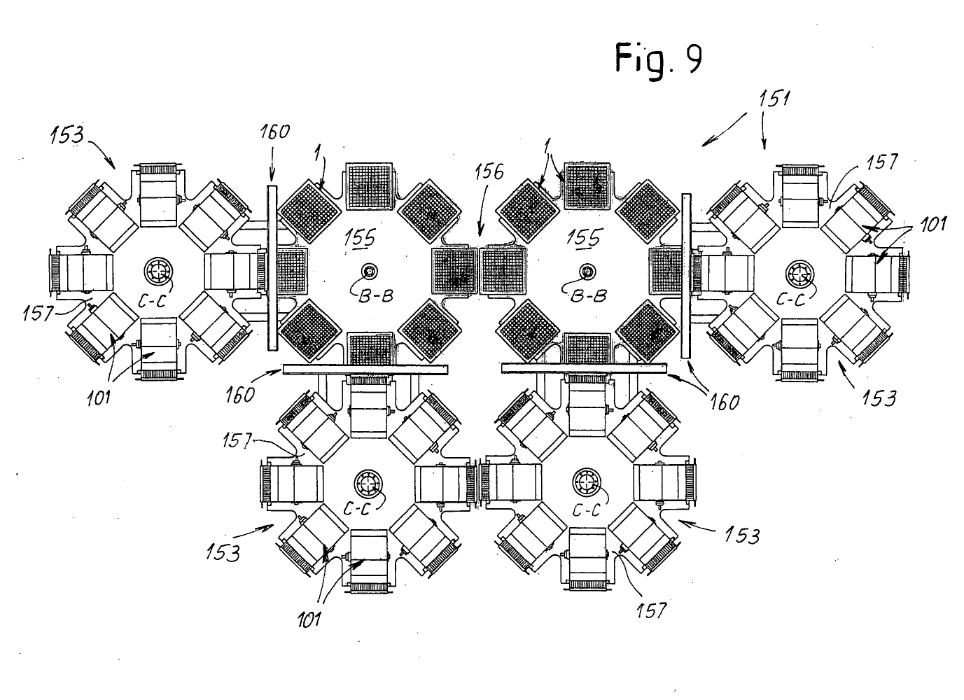

FIG. 9 shows a more complex arrangement with a filling station 151 which comprises two carousels 155 and four filling machines 153. In an interchange area 156 the trays 1 can be transferred from one to the other of the carousels 155, and at this end hollow positions (not shown in the drawing) must be obviously provided. This arrangement allows to work with tesserae or tiles P of 32 different types.

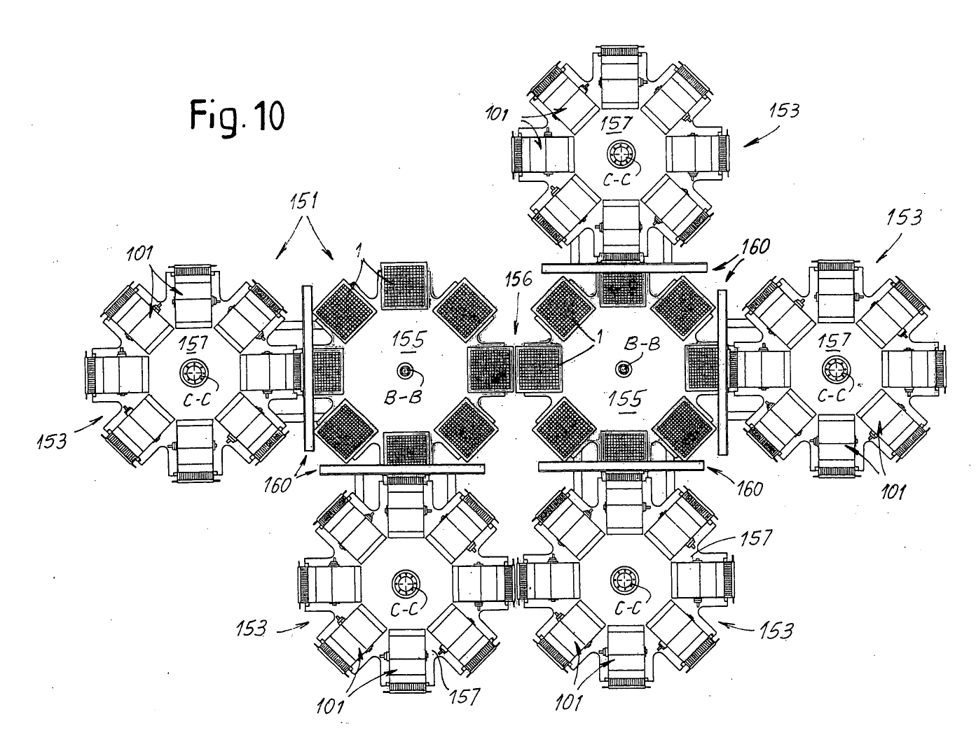

FIG. 10 shows a filling station 151 analogous to that of FIG. 9, but with one more filling machine 153, for a total of four filling machines 153, which allow to work with 40 different types of tiles, for example with 40 different colors or nuances of color. The carousels 155 are two and allow the change or passage of trays 1 from one to the other in the interchange area, again indicated with number 156. In this case, as in the previous configurations, a station is provided, for example in the area indicated with C, where the trays 1 are loaded on the carousel 155 to be filled and the trays filled by the machines 153 are extracted.

In other embodiments more selective filling devices 159 can be provided, arranged around the axis B-B of rotation of the carousel 155, to each selective filling device, which remains fixed, being in this case associated one device 101. In this way it is possible to fill simultaneously more trays of tiles by passing them from one to the other of the selective filling devices 159 through stepped rotation of the carousel 155. Preferably two positions of the carousel 155 are left available for loading the empty trays and unloading the full trays, or for transferring the trays from one to the other of several carousels combined to each other, to obtain filling of the trays of tiles with a greater number of tiles of different colors.

FIGS. 12, 13, 14A, 14B, 14C, and 14D show a possible embodiment of the selective filling device 159.

The selective filling device 159 is arranged above a stepped feeding path of the tray 1, which can be for example supported by a guiding and handling system carried by the carousel 155 at the respective housing seat of the tray 1. Number 11 generically indicates the ideal plane of horizontal motion of the tray 1. Optimal handling can be obtained for example with a threaded bar system controlled by a stepping motor, so that the tray can be fed in a controlled stepped manner below the selective filling device 159, to position each time a row of seats 3 of the tray 1 close to the filling members of the device 159 and therefore fill a row of seats at a time in the manner described below.

Above the movement plane 11 the surface 167 develops with the channels 167A forming the conveying system of the tiles P.

In general, the tesserae or tiles P have been previously oriented by the device 101 for example with the so-called beautiful face upwards, or alternatively with the back face upwards.

In front of the terminal end of the channels 167A of each surface 167 of each device 101 a movable support is arranged, indicated as a whole with number 15, pivotally mounted around an axis 17, substantially orthogonal to the longitudinal development of the channels 167A.

As it is shown in the side view of FIG. 12, the support 15 has a seat 15A developing along all the front where the channels 167A of the respective orienting device 101 are arranged, and has a front abutment 15B arranged in front of the end 167B of the channels 167A, at such a distance from these latter (when the support 15 is in resting conditions) that between the ends 167B of the channels and the abutment 15B there is sufficient space for a tile or tessera P in front of each channel 167A.

Close to the filling area for filling the trays a gantry structure 19 is arranged with a substantially horizontal crossbar and two uprights positioned at such a distance as to allow the selective positioning of each surface 167 in the loading area of the tiles P. Along the structure 19 a cursor 21 is guided, movable according to the double arrow 121 in a substantially vertical direction, and therefore substantially orthogonal to the feeding plane 11 for the trays 1.

Gripping members or elements 23 are associated to the cursor 21. In some embodiments of the present invention the gripping elements 23 are as many as the channels 167A of a single orienting device 101. According to some embodiments, each gripping member or element 23 comprises a sucker or other sucking member arranged at the lower end of the respective gripping element. Each sucker or other sucking member of each gripping element 23 is aligned with one of the channels 167A of the device 101, which is temporarily aligned with the selective filling device 159, so that a lowering movement, according to arrow f21, of the gripping elements 23 and of the cursor 21 carrying them causes a movement of each sucker towards the surface facing upwards of a respective tessera or tile P temporarily arranged in the seat 15A of the movable support 15. In this way, the lowering movement of the gripping elements 23 allows engaging simultaneously all the tiles P that have been brought from the single channels 167A to the seat 15A of the movable support 15.

The vertical movement of the cursor 21 and of the gripping elements 23 according to the double arrow 121 can be obtained in any adequate manner. For example, the cursor 21 can be guided by means of guide bars 21A in guide bushes 21B integral to the crossbar of the bearing structure 19. Between the two guide bars 21A, to the cursor 21 is connected a rack 31 engaging with a gear wheel 33 carried into rotation by a first actuator, for example an electric motor schematically indicated with number A1, which gives the motion to a drive shaft 35. In other embodiments of the present invention, the motor can be replaced with a linear actuator, for example with a cylinder-piston actuator mounted directly on the crossbar 19A of the bearing structure 19, whose rod is engaged to the cursor 21.

The cursor 21 cooperates with the movable support 15, so that the movable support 15 pivots around the support axis 17 when the cursor with the gripping elements 23 is lowered. To this end the cursor 21 can have adequate thrust members acting on the profile of the movable support 15. The arrangement of these elements is preferably such that before starting the pivoting movement, according to the arrow f15, of the movable support 15, the gripping elements 23 have been entered into contact with the tiles deposited on the seat 15A of the support 15 and therefore these tiles have been engaged by the suckers or by other gripping members of the gripping elements 23. Consequently, the subsequent further lowering of the gripping elements 23 of the cursor 21, and therefore the further pivoting movement of the movable support f15, allows lowering the row of tiles P engaged to the gripping elements 23, which can descend until they deposit the single tiles P in the seats below of a tray 1 positioned below the selective filling device 159.

The subsequent lifting of the cursor 21 and of the gripping elements 23 causes the pivoting movement, in the direction opposite to the arrow f15, of the movable support 15, which returns in the rest position, i.e. with the seat 15A aligned with the exits 13B of the channels 13. The return movement of the support 15 can be obtained with spring return members, not shown, for example spiral springs arranged on the axis of oscillation of the support 15.

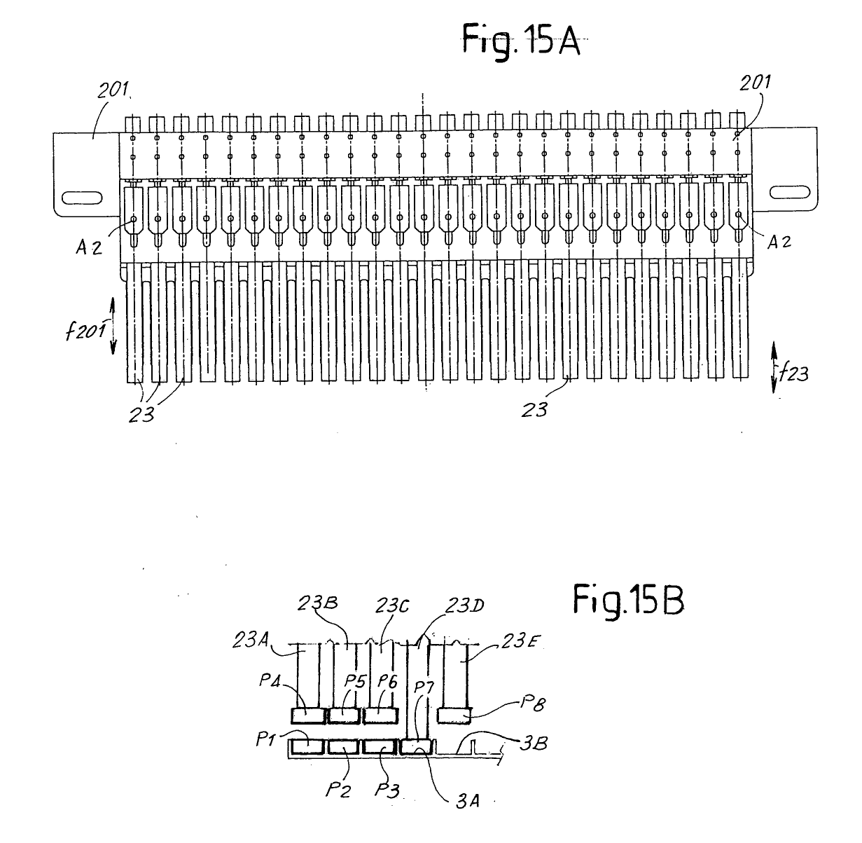

The functioning of the device described above will be better understood with reference to the operative sequence of FIGS. 14A to 14D.

FIG. 14A shows the initial phase of an operation of insertion of a row of tesserae or tiles P into a corresponding row of seats 3 of a tray 1 positioned below the selective filling device 159. In the seat 15A of the movable support 15 a row of tesserae or tiles P is arranged, in a number equal to the number of the channels 167A, generally, but not necessarily, equal to the number of seats 3 in a row of the tray 1. When the number of the channels 167A is different from, for example lower than, the number of seats 3 in a row of the tray 1, it is possible to provide for a transverse movement of the gripping elements with respect to the tray.

In the subsequent phase (FIG. 14B) the gripping elements 23 have descended until they enter into contact each with a respective tessera or tile P held on the movable support 15, before the latter starts its downwards movement. In FIG. 14C the movable support 15 is rotated by about 90° (in counterclockwise direction in the example shown) so as to let the gripping elements 23 pass, with the tiles P engaged to the end suckers of the gripping elements.

The gripping elements 23 are lowered until each tile T is inserted in the respective seat 3 of the tray 1. At this point, in all the seats 3 of a row tesserae T are inserted, but not necessarily all these tesserae will be deposited in these seats. For example, in the case in which the tray 1 shall be filled all with tesserae or tiles of the same color, fed along the channels 167A associated to the orienting device 101 temporarily aligned with the selective filling device 159, all the gripping elements 23 will be disabled, i.e. the suction through the suckers arranged at the ends of the elements 23 will be interrupted and all the tiles P will be released, so that the subsequent lifting of the gripping elements 23, till they return in the position of FIG. 14A, will occur only after the release of all the tesserae or tiles P. All the gripping elements will be free to engage a subsequent row of tiles.

Vice versa, if the pattern to be obtained provides, for instance, for an alternate arrangement of tiles of different color, as illustrated by way of example in FIG. 11, only some of the gripping elements 23 will be disabled and more precisely those corresponding to the positions of the seats 3, in which shall be inserted the tiles of the color corresponding to the tiles fed along the channels 167A of the device 101 temporarily aligned with the selective filling device 159. In the example of FIG. 11, each row of seats 3 will be filled only in the even positions or in the odd positions, to obtain a chessboard pattern. This means that at each cycle of lowering of the gripping elements 23, only the gripping elements in even position in a cycle and in odd position in the subsequent cycle will be disabled, releasing respective tiles or tesserae P engaged in the phase preceding the pivoting movement of the movable support 15.

In the subsequent lifting movement (FIG. 14D) some gripping elements 23 will return to their lifted position with the tessera or tile T, previously engaged, still connected to the end thereof. When the movable support 15 returns in the rest position (FIG. 14A), the elements 23 descend and, in correspondence of those, that have been disabled in the previous phase, there will be a space on the support 15 in correspondence of the seat 15A for the load of a new tile coming from the respective channel 13, whilst in correspondence of the gripping elements 23 that have not been disabled the seat 15A is occupied by the tessera or tile T picked up during the previous cycle, which is remained engaged to the respective gripping element 23. The movement of the tiles along the channels 167A during the lowering phase of the gripping elements 23 can be avoided by the presence of the elements 23 in front of the channels, which elements form abutment or temporary stop members for stopping the forward movement of the tiles in the channels 167A.

Definitively, with the subsequent forward movement of the tiles along the channels 167A in the seat 15A tiles will be inserted only in correspondence of the gripping elements 23 that have been previously disabled and that have therefore released their tile in the corresponding seat of the tray below.

In the subsequent phase the gripping elements 23, all actuated, engage each the respective tile P, which is the same of the previous cycle for those gripping elements 23 that have not been disabled in the previous cycle, and which is a new tile for those gripping elements 23 that have been disabled in the previous step.

In the meantime, the tray 1 has moved forwards by one step to bring a new row of seats 3 below the gripping elements 23. The cycle repeats as described above, bringing the tiles P engaged by the members 23 in the respective seats 3 of the subsequent row and disabling selectively the gripping elements 23 that shall release the respective tesserae or tiles in this subsequent row. In the example of the drawing of FIG. 11, as mentioned, the gripping elements 23 will be selectively disabled, each every two cycles, so as to obtain a chessboard disposition of the tiles fed by the device 101 that in a given work phase is aligned with the selective filling device 159.

As the machine provides for a plurality of (for instance eight) orienting devices 101, once for example the black tiles PN have been inserted in a tray 1, it is possible to rotate the rotating table 157 so as to align to the selective filling device 159 another of the various orienting devices 101, which feeds for example the white tiles PB to the selective filling device 159, with a process substantially equal to that described above.

Having available various orienting devices 101 it is possible to obtain also a complex pattern on a tray 1, using combination of tiles P different one from the other in color, material, surface finishing or also dimension (having in this case a tray 1 with seats 3 of dimensions different one from the other).

Once having filled a tray, the carousel 155 is rotated by one step to fill the subsequent tray.

If the machine provides for more rotating tables 157 and, in case, more carousels 155, each tray can be filled with tesserae or tiles P fed by the devices 101 carried by more rotating tables 157, obtaining a combination of a high number of tiles P different one from the other.

Loading and unloading the trays from the carousels 155 can occur manually or through automatic load and unload systems, easily to be designed by those skilled in the art.

After filling, each tray 1 can pass below an automatic vision and control system, with a video camera that shoots the image of each tray 1 filled with tesserae or tiles P, PN, PB and compares it with the required pattern, stored in a central control unit. An operator or an automatic system can then provide for correcting any mistakes, for example removing the damaged tiles or the tiles of color different than that foreseen for the stored pattern.

FIGS. 15A and 15B show an improved embodiment of the selective filling device 159. The same numbers indicate parts identical or equivalent to those illustrated in the previous figures. FIG. 15A shows a front view of the gripping elements 23, isolated from to the other elements of the selective filling device 159, which remain substantially unchanged with respect to what is shown in the previous figures. The gripping elements 23 are carried by a crossbar 201 which is provided with a first lowering and lifting movement according to the double arrow 1201, imparted by the motor or actuator A1. The actuator A1 causes therefore a first lowering movement, common to all the gripping elements 23.

In the example of FIGS. 15A and 15B each single gripping element 23 is provided in turn with a second lowering movement according to double arrow f23 relative to the common support crossbar 201. The movement according to f23 is imparted to each single gripping element 23 through a respective second actuator A2, for example a pneumatic or hydraulic piston cylinder. Each gripping element 23 is therefore provided with a lowering stroke common to all the gripping elements 23 and with an over-travel imparted individually in a selective manner to each gripping element 23.

The described double selective movement allows to obtain the functioning illustrated schematically in FIG. 15B. Here a cross section of a tray 1 is shown, with a row of seats for as many tesserae or tiles P. Above this row of seats there is the row of gripping elements 23 that, in the arrangement of FIG. 15B, have been lowered through the actuator A1 by a common lowering stroke (the members 23A, 23B, 23C) and one of them has been lowered also by a further stroke by the respective second actuator A2, and it is therefore at a height lower than the members 23A, 23B, 23C. Each gripping element 23A-23D holds a tile or tessera, indicated, starting from left, with P4, P5, P6, P7, . . . . FIG. 15B obviously shows only a portion of the entire series of gripping elements 23 of the device 159 and it must be understood that the row of gripping elements 23 continuous for all the width of the tray 1.

In the example shown in FIG. 15B, some of the seats of the tray 1 have been previously already filled with tesserae or tiles P1, P2, P3. The seat 3A must receive the tile P7, the seat 3B must remain empty and therefore the tiles P4, P5, P6, and P8 must remain engaged to the retaining members, whilst the tile P7 held by the gripping element 23D must be deposited in the seat 3B. The lowering over-travel of the gripping element 23D controlled by the respective actuator A2 allows this single gripping element to insert and release the tile P7 in the seat 3B, instead of making it fall from the top, without reciprocal interference of the remaining tiles.

This improved embodiment of the selective filling device 159 can be used also with other feeding systems for feeding tiles, different than the device 101, and can be used also without the system of carousels and rotating tables 155, 157 described above.

Therefore, an object of the present invention is also a filling device for filling trays with tesserae or tiles comprising: a series of feeding channels for feeding the tesserae; a movable support arranged at the exit of the feeding channels, so as sequentially to receive rows of tesserae formed by tesserae fed by the feeding channels; a series of gripping elements, each of which can be actuated and disabled selectively, aligned with the feeding channels and with the movable support so as to pick up the tesserae from the movable support and to transfer them selectively in seats of a tray being filled; a rest surface below the movable support, on which said trays are positioned, to receive selectively the tesserae from said gripping elements; wherein each gripping element is provided with a lowering movement independent of the remaining gripping elements, to deposit individually a tile in a seat of the tray independently of the adjacent gripping elements. Preferably, the gripping elements are provided with a common lowering movement and with an individual lowering movement. Preferably, a first actuator controls the common lowering movement of the gripping elements and a second actuator for each gripping element controls the selective individual lowering movement of the respective gripping element.

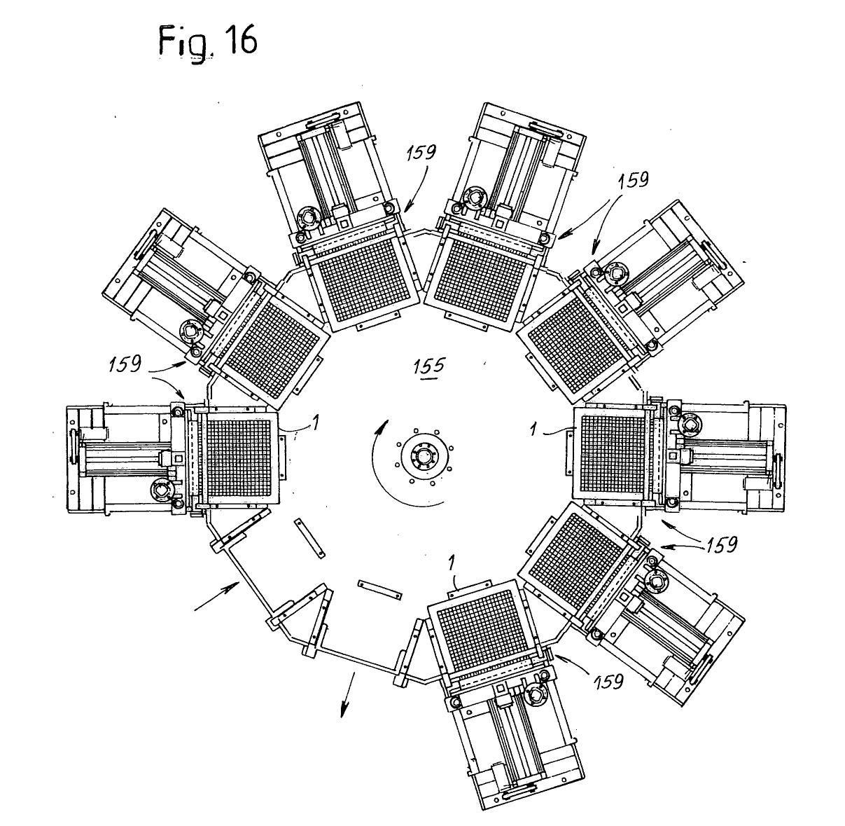

FIG. 16 shows a plan view of an embodiment of a filling station for filling trays 1 with tesserae or tiles P fed by a plurality of feeding or orienting devices 101. In this case a carousel 155 is provided with a plurality of seats for as many trays 1. In the illustrated example ten seats or positions are provided. One of them is used to load the trays and one to unload the trays. The remaining ones are associated each to a respective selective filling device 159. In the illustrated example eight selective filling devices 159 are therefore provided, arranged about the axis of rotation of the carousel 155. To each selective filling device 159 is associated a feeding device or an orienting and feeding device 101. In this way it is possible to work simultaneously on eight trays instead of on only one tray as in the example of FIGS. 4 to 6. The cost of the plant is higher due to the need of providing eight selective filling devices 159, but the productivity is highly increased. It is also possible to combine more carousels, making the trays pass from one to the other with a transferring unit arranged at respective positions of the two carousels that are devoid of device 159. In other embodiments it is also possible to provide selective filling devices 159 at the transit positions of the trays from one to the other carousel, simply by arranging suitable conveyor or transferring means, which make the trays pass below the selective filling devices 159 inserting them or extracting them gradually from the respective carousel.

It is understood that the drawing only shows an example provided by way of a practical demonstration of the present invention, which can vary in forms and arrangements without however departing from the scope of the concept underlying the invention. Any reference numbers in the appended claims are provided for the sole purpose of facilitating reading of the claims in the light of the description and the drawing, and do not in any manner limit the scope of protection represented by the claims.

1. A feeding device for feeding mosaic tesserae or tiles, the device comprising:
a containing hopper for containing the tiles with an exit mouth for the exit of the tiles, wherein a rotating member is associated with said exit mouth, which is provided with a plurality of adjacent annular channels along an axial development of said rotating member, wherein cross dimensions of said annular channels are such as to allow insertion of said tiles in said channels, and wherein rotation of said rotating member causes a supply of said tiles from said annular channels into a plurality of corresponding feeding channels adjacent one to the other, in a number corresponding to a number of annular channels in said rotating member.

2. A device as claimed in claim 1, wherein said annular channels have such cross dimensions as to allow the insertion of said tiles only with a preset orientation.

3. A device as claimed in claim 2, wherein a contrast element is associated with said rotating member, which prevents the tiles oriented in an incorrect manner from being inserted in said annular channels.

4. A device as claimed in claim 1, wherein a wall extends around said rotating member, which defines an angular position of discharging the tiles from the annular channels.

5. A device as claimed in claim 4, wherein an agitating element is associated with said wall for agitating the tiles, which facilitates the insertion of the tiles in the annular channels of the rotating member.

6. A device as claimed in claim 1, wherein one or more baffles are arranged in said hopper.

7. A device as claimed in claim 1, wherein a movable support is arranged at the exit of said feeding channels, said movable support being suitable to receive in a sequential manner rows of tesserae or tiles from said feeding channels.

8. A device as claimed in claim 7, wherein said movable support is provided with a pivoting movement about an axis substantially orthogonal to said feeding channels.

9. A device as claimed in claim 1, further comprising:
a filling device for filling trays with tesserae or tiles fed along said feeding channels, said filling device comprising: a movable support arranged at the exit of said feeding channels, so as sequentially to receive rows of tesserae formed by tesserae fed by the feeding channels; a series of gripping elements, each of which can be actuated and disabled selectively, aligned with the feeding channels and with the movable support so as to pick up the tesserae from the movable support and to transfer the tesserae selectively in seats of a tray being filled; a rest surface below the movable support, on which said trays are positioned, to receive selectively the tesserae from said gripping elements, wherein each gripping element is provided with a lowering movement independent of the remaining gripping elements, to deposit individually a tessera in a seat of the tray independently of the adjacent gripping elements.

10. A device according to claim 9, wherein the gripping elements are provided with a common lowering movement and with an individual lowering movement.

11. A device according to claim 10, wherein a first actuator controls the common lowering movement of the gripping elements and a second actuator for each gripping element controls the selective individual lowering movement of the respective gripping element.

12. A machine for filling trays with mosaic tesserae or tiles, the machine comprising:
at least one rotating table, rotatable about an axis of rotation with respect to a bearing structure; and
at least one selective filling device for filling a tray with mosaic tesserae or tiles, wherein a plurality of feeding devices are arranged on said rotating table, and wherein said rotating table is controlled so as to bring selectively the one or the other of said feeding devices in at least one filling position, at least one of said plurality of feeding devices comprising a containing hopper for containing the tiles with an exit mouth for the exit of the tiles and a rotating member associated with said exit mouth, which is provided with a plurality of adjacent annular channels along an axial development of said rotating member, wherein cross dimensions of said annular channels are such as to allow insertion of said tiles in said channels, and wherein rotation of said rotating member causes a supply of said tiles from said annular channels into a plurality of corresponding feeding channels adjacent one to the other, in a number corresponding to a number of annular channels in said rotating member.

13. A machine for filling trays with mosaic tesserae or tiles, the machine comprising:
at least one carousel, rotatable about an axis of rotation with respect to a bearing structure;
a plurality of filling devices for filling trays with mosaic tesserae or tiles, said selective filling devices being fixedly arranged around the axis of rotation of said carousel, wherein a feeding device is associated to each selective filling device, said feeding device comprising a containing hopper for containing the tiles with an exit mouth for the exit of the tiles and a rotating member associated with said exit mouth, which is provided with a plurality of adjacent annular channels along an axial development of said rotating member, wherein cross dimensions of said annular channels are such as to allow insertion of said tiles in said channels, and wherein rotation of said rotating member causes a supply of said tiles from said annular channels into a plurality of corresponding feeding channels adjacent one to the other, in a number corresponding to a number of annular channels in said rotating member.

14. A machine as claimed in claim 12, wherein said selective filling device is supported in said filling position and interacts selectively with a plurality of said feeding devices.

15. A machine as claimed in claim 12, wherein a movable support is arranged at the exit of said feeding channels, said movable support being suitable to receive in a sequential manner rows of tesserae or tiles from said feeding channels, said selective filling device comprising:
a series of gripping elements, each of which can be actuated and disabled selectively, aligned with said feeding channels and with the movable support of the feeding device which is at said selective filling device, so as to pick up the tesserae or tiles from the movable support associated to the feeding device which is in correspondence of the filling device, and to transfer the tesserae or tiles selectively in seats of a tray being filled;
support means below said series of gripping elements, on which said trays are arranged, so as to receive selectively the tesserae or tiles from said gripping elements.

16. A machine as claimed in claim 15, wherein said gripping elements are controlled by a first common actuator to perform a first lowering movement, and wherein each gripping element is provided with a second individual actuator to perform a second lowering movement constituted by an over-travel with respect to said first lowering movement, to allow each gripping element to be lowered beyond a common lowering position to which said gripping elements are brought by said first common actuator.

17. A machine as claimed in claim 15, wherein said trays and said gripping elements are movable one with respect to the other, so that with subsequent operations the gripping elements place tesserae or tiles into subsequent rows of seats of said tray.

18. A machine as claimed in claim 15, wherein each of said gripping elements comprises a suction system for retaining the tiles.

19. A machine as claimed in claim 15, wherein said gripping elements are provided with a lowering and lifting movement from said feeding channels at a height of discharging the tesserae or tiles in a tray below and vice versa.

20. A machine as claimed in claim 19, wherein the movement of said movable support is synchronized with the lowering and lifting movement of said gripping elements.

21. A machine as claimed in claim 15, wherein said gripping elements are electronically controlled so as to transfer, in subsequent rows of seats in said tray, tesserae or tiles according to a preset pattern, through selective disabling of the gripping elements corresponding to positions of seats inside which said tesserae or tiles must be transferred and maintaining active the gripping elements corresponding to seats into which said tesserae or tiles must not be inserted.

22. A machine as claimed in claim 12, wherein at least one handling member is associated to said at least one rotating table for a plurality of trays, said at least one handling member being controlled and arranged so as to feed sequentially a plurality of trays to said rotating table.

23. A machine as claimed in claim 22, wherein said handling member comprises a plurality of seats in which corresponding trays for said tiles can be inserted and from which said trays for said tiles can be extracted.

24. A machine as claimed in claim 23, wherein said handling member comprises a carousel with said plurality of seats, said carousel being rotatable about an axis so as to move said seats according to a circular trajectory.

25. A machine as claimed in claim 24, wherein said rotating table and said carousel rotate about substantially parallel axes.

26. A machine as claimed in claim 23, further comprising handling members for controlled handling, according to a numerically controlled axis of the trays, in the direction of insertion and extraction of the trays from the respective seats, so as to fill selectively said trays according rows of tesserae or tiles extending orthogonally to the direction of insertion and extraction.

27. A machine as claimed in claim 12, further comprising a plurality of rotating tables.

28. A machine as claimed in claim 27, further comprising a plurality of handling members for a plurality of trays, controlled and arranged so as to feed sequentially a plurality of trays to one or more of said rotating tables.
